(19) United States
(12) Patent Application Publication
(10) Pub. No.: US 2019/0014712 A1
(43) Pub. Date: Jan. 17, 2019

(54) GARDENING TOOL FOR TAMPERING AND AERATING SOIL

(71) Applicant: Lourdes Rodriguez, Fort White, FL (US)

(72) Inventor: Lourdes Rodriguez, Fort White, FL (US)

(21) Appl. No.: 15/651,563

(22) Filed: Jul. 17, 2017

(51) Int. Cl. A01B 1/20; A01B 1/24; E02D 3/046; A01B 1/06; A01C 21/00; A01G 25/00

(52) U.S. Cl. CPC A01B 1/20; A01B 1/243; A01G 25/00; A01B 1/06; A01C 21/00; E02D 3/046

(57) ABSTRACT

A gardening tool is described comprising a base having a substantially flat plate with a face surface and a back surface; and one or more tines connected to and extending substantially perpendicular to a horizontal plane of the face surface of the flat plate. In some embodiments, the base of the tool is formed into a crescent shape.

### FIELD OF THE INVENTION

This disclosure relates to gardening tools. More particularly, it relates to a gardening tool for tampering and aerating the soil.

### BACKGROUND OF THE INVENTION

The cultivation of plants generally requires a variety of tools, each with unique functions in the process. Gardening hoes, shovels, spades or picks may be used to break up soil; manual aerating tools may be used to aerate the soil; and tampers may be used for compacting soil.

The break-up of soil is an important factor in cultivating plants and/or opening up the soil surface for planting of seeds and seedlings. Further, the tools used for breaking up soil are also used to dig around the base of plants to help with removal of weeds and unwanted structures, e.g., rocks.

Soil aeration is an important factor in the normal growth of plants. The supply of oxygen to roots in adequate quantities and the removal of CO₂ from the soil atmosphere are very essential for healthy plant growth. When the supply of oxygen is inadequate, the plant growth either retards or ceases completely as the accumulated CO₂ hampers the growth of plant roots. The abnormal effect of insufficient aeration on root development is most noticeable on root crops. Abnormally shaped roots of these plants are common on the compact and poorly aerated soils. As a result, the penetration and development of the roots are poor. An undeveloped root system cannot absorb sufficient moisture and nutrients from the soil. The microorganisms living in the soil also require oxygen for respiration and metabolism. Some of the important microbial activities such as the decomposition of organic matter, nitrification, and sulphur oxidation depend upon oxygen present in the soil air. The deficiency of air (oxygen) in soil slows down the rate of microbial activity. For example, the decomposition of organic matter is retarded and nitrification arrested. The microorganism population is also drastically affected by poor aeration. Poor aeration results in the development of toxins and other injurious substances, such as ferrous oxide, H₂S gas, and CO₂ gas in the soil. Under poor aeration conditions, plants exhibit water and nutrient deficiency. Insufficient aeration of the soil also leads to the development of diseases, for example, wilt of gram and dieback of citrus and peaches.

Tampering around newly planted seedlings, bushes, trees, etc. is important for ensuring good contact is made between the soil and roots of the plant. The tampering process also provides better seating of the subsurface roots within the soil such that the plant's structure above the surface of the soil remains firmly in place while the root structure grows and provides the necessary stability to the plant.

For each of the aforementioned aspects of plant cultivation, a variety of tools must be used. This requires the gardener to maintain numerous tools that must be carried back and forth from the storage area to the garden each time they are used.

### SUMMARY OF THE INVENTION

The present disclosure enables a gardener to utilize a single tool to break up, tamper and aerate the soil, allowing a gardener to carry fewer tools to the garden or site of planting projects. The shape of some embodiments of the tool also makes the process of tampering and aerating the soil around the base of plants, particularly trees, easier. Embodiments of the tool are also useful for assisting in the application of fertilizer to established plants/shrubs and trees. For instance, the tools described herein can easily aerate around established plants/shrubs/trees, allowing for a user to then apply nutrients and/or fertilizer and water around the base of the plants/shrubs/trees.

In certain aspects, the present disclosure provides gardening tools comprising a base comprising a substantially flat plate with a face surface and a back surface and one or more tines connected to and extending substantially perpendicular to a horizontal plane of the face surface of the flat plate. In some embodiments, the tool further comprises a shaft extending substantially perpendicular to a horizontal plane of the back surface of the base, to which a handle may be removably attached. In further embodiments, the perimeter of the flat plate forms a substantially crescent shape having two pointed ends.

In other aspects, the present disclosure provides methods of tampering and/or aerating and/or fertilizing soil/plants. The methods allow for tampering and/or aerating and/or fertilizing plants and trees around their base. The methods comprise the step of pressing or striking the surface of soil with a tool comprising a base comprising a substantially flat plate with a face surface and a back surface and one or more tines connected to and extending substantially perpendicular to a horizontal plane of the face surface of the flat plate, such that the face surface presses or strikes against the surface of the soil while the one or more tines pierce the surface of the soil. The methods can further comprise applying water/nutrients and/or fertilizer to the surface of the soil.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows a perspective view of an embodiment of a gardening tool of the present disclosure.

FIG. 2 shows a side view of the gardening tool of FIG. 1.

FIG. 3 shows a bottom view of the gardening tool of FIG. 1.

FIG. 4 shows a top view of the gardening tool of FIG. 1.

FIG. 5 shows an embodiment of a gardening tool of the present disclosure with a handle attached to the tool's shaft

FIG. 6 shows a perspective view of an embodiment of a gardening tool of the present disclosure.

### DETAILED DISCLOSURE OF THE INVENTION

Aspects of the present disclosure provide a gardening tool for tampering and aerating soil, particularly around the base of plants, e.g., trees. The present disclosure enables a gardener to utilize a single tool to both tamper and aerate the soil. The shape of some embodiments of the tool also makes the process of tampering and aerating the soil around the base of plants, particularly trees, easier.

Several aspects of the disclosure are described below, with reference to illustrations for illustrative purposes only. It should be understood that numerous specific details and relationships are set forth to provide a full understanding of the disclosure. One having ordinary skill in the relevant art, however, will readily recognize that the invention disclosed can be practiced without one or more of the specific details. Unless otherwise defined, all terms of art, notations and other scientific terms or terminology used herein are intended to have the meanings commonly understood by those of skill in the art to which this disclosure pertains. In some cases, terms with commonly understood meanings are defined herein for clarity and/or for ready reference, and the inclusion of such definitions herein should not necessarily be construed to represent a substantial difference over what is generally understood in the art. It will be further understood that terms, such as those defined in commonly used dictionaries, should be interpreted as having a meaning that is consistent with their meaning in the context of the relevant art and/or as otherwise defined herein.

The terminology used herein is for the purpose of describing particular embodiments only and is not intended to be limiting of the invention. As used herein, the articles “a”, “an” and “the” should be understood to include plural reference unless the context clearly indicates otherwise.

The phrase “and/or,” as used herein, should be understood to mean “either or both” of the elements so conjoined, i.e., elements that are conjunctively present in some cases and disjunctively present in other cases.

As used herein, “or” should be understood to have the same meaning as “and/or” as defined above. For example, when separating a listing of items, “and/or” or “or” shall be interpreted as being inclusive, i.e., the inclusion of at least one, but also including more than one, of a number of items, and, optionally, additional unlisted items. Only terms clearly indicated to the contrary, such as “only one of” or “exactly one of” or, when used in the claims, “consisting of” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of”

In one aspect, the present disclosure provides a gardening tool comprising a base comprising a substantially flat plate with a face surface and a back surface and one or more tines connected to and extending substantially perpendicular to a horizontal plane of the face surface of the flat plate. In one embodiment, the perimeter of the flat plate forms a substantially crescent shape having pointed ends at each point of the crescent. The base of the tool provides the tampering functionality; the tines provide the aerating functionality; and the points formed at each end of the crescent shape of the base provide the soil breakup functionality.

In some embodiments, the tool further comprises a shaft extending substantially perpendicular to a horizontal plane of the back surface of the base. In some embodiments, the shaft is centrally positioned on the back surface of the base. The shaft may also comprise a handle which may be removably attached to the shaft. In further embodiments, the shaft forms a handle, which is integral to the shaft itself.

In some embodiments, each of the tines on the tool comprise an elongated stem having a head opposite the face surface of the flat plate, the head of the stem converging into a point. The head of the stem may also converge into a diamond shaped point. In some embodiments, the tines (when more than one tine is included on the tool) are in a substantially parallel spaced apart relation. In further embodiments, the tines may be removably connected to the flat plate.

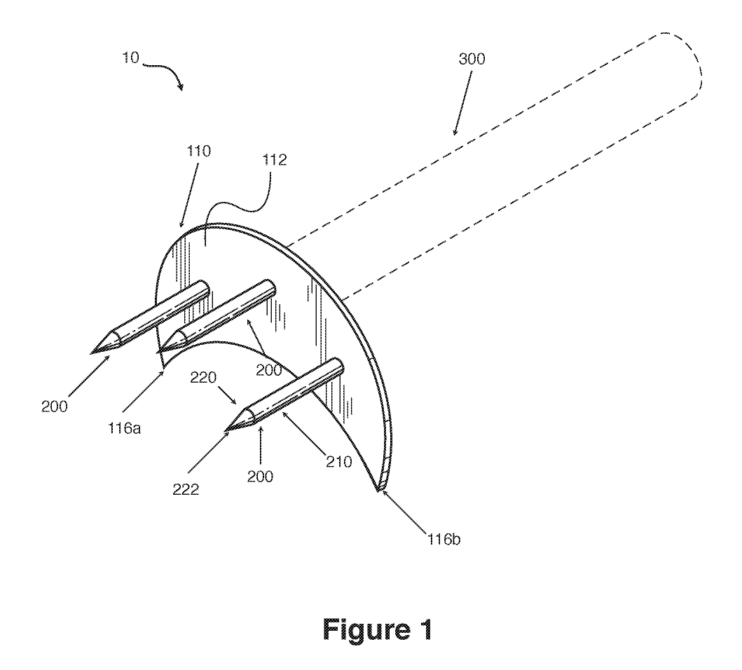

FIGS. 1 through 5 show a gardening tool of at least one embodiment of the present disclosure. The tool 10 comprises a base 100 having a substantially flat plate 110 with a face surface 112 and a back surface 114 and one or more tines 200 connected to and extending substantially perpendicular to a horizontal plane of the face surface of the flat plate. As illustrated, the flat plate 110 may form a substantially crescent shape having pointed ends 116a, 116b at each point of the crescent.

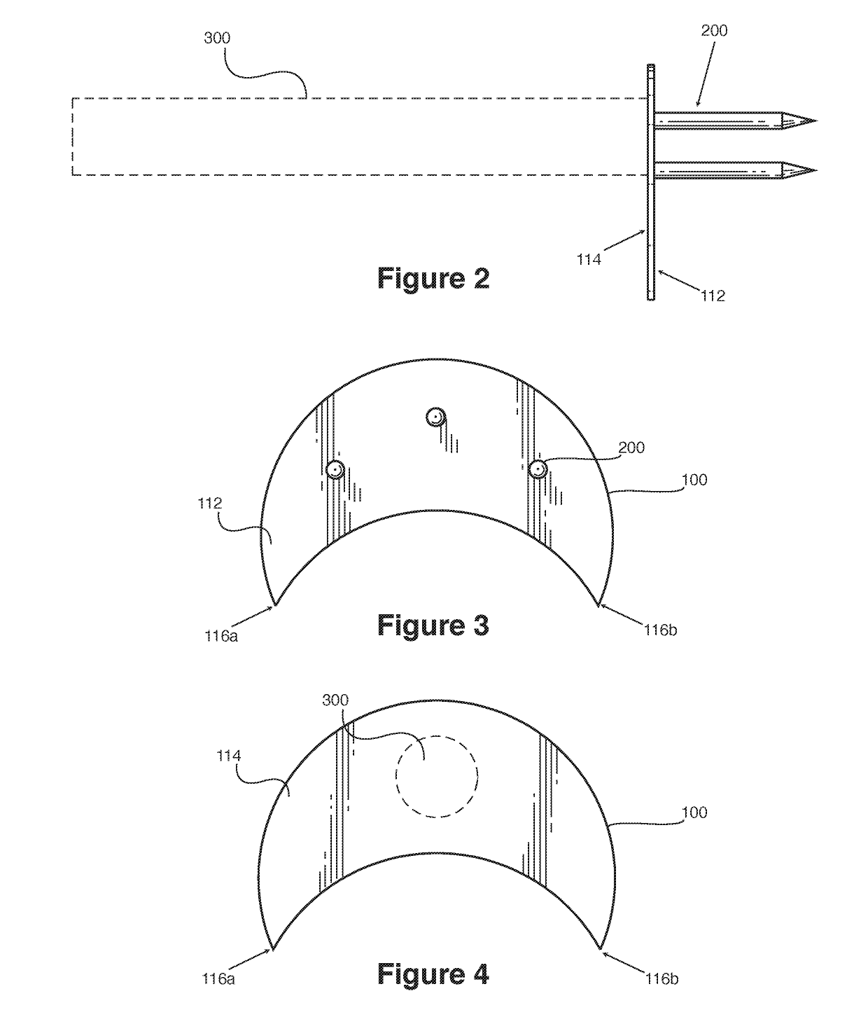

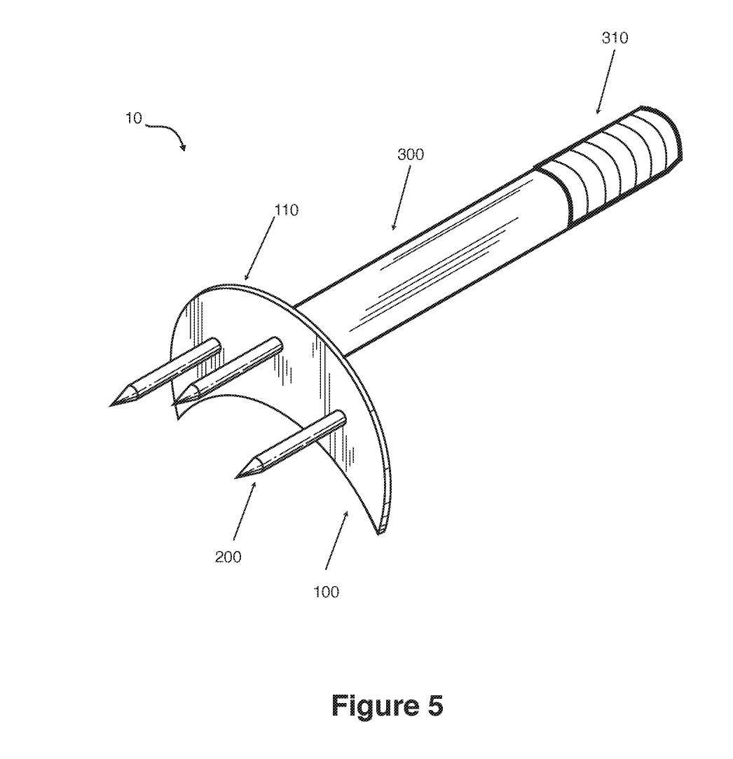

As shown in FIGS. 1 and 2, the tool 10 further comprises a shaft 300 extending substantially perpendicular to a horizontal plane of the back surface 114 of the base 100. As shown in FIG. 4, the shaft 300 may be centrally positioned on the back surface 114 of the base 100. The shaft 300 may also comprise a handle 310 which may be removably attached to the shaft. As shown in FIG. 5, the shaft 300 may form a handle 310 at its end, which is integral to the shaft itself.

Each of the tines 200 on the tool 10 comprises an elongated stem 210 having a head 220 opposite the face surface 112 of the flat plate 110, the head of the stem converging into a point 222. In some embodiments, the head 220 of the stem 210 may also converge into a diamond shaped point. In some embodiments and as illustrated in FIGS. 1, 2, 3 and 5, the tines 200 (when more than one tine is included on the tool) are in a substantially parallel spaced apart relation. In further embodiments, the tines 200 may be removably connected to the flat plate 110.

FIG. 2 illustrates the tool 10 as viewed from its side. As shown, the tines 200 and shaft 300 each extend outward perpendicularly from each of the face surface 112 and back surface 114, respectively. FIG. 3 illustrates the tool 10 as viewed from the face surface 112 of the flat plate 110. As shown, the tines 200 are in a spaced apart relation to each other. Further, FIG. 4 illustrates the tool 10 as viewed from the back surface 114 of the flat plate 110. As shown, the shaft 300 is centrally positioned on the back surface 114 of the base 100.

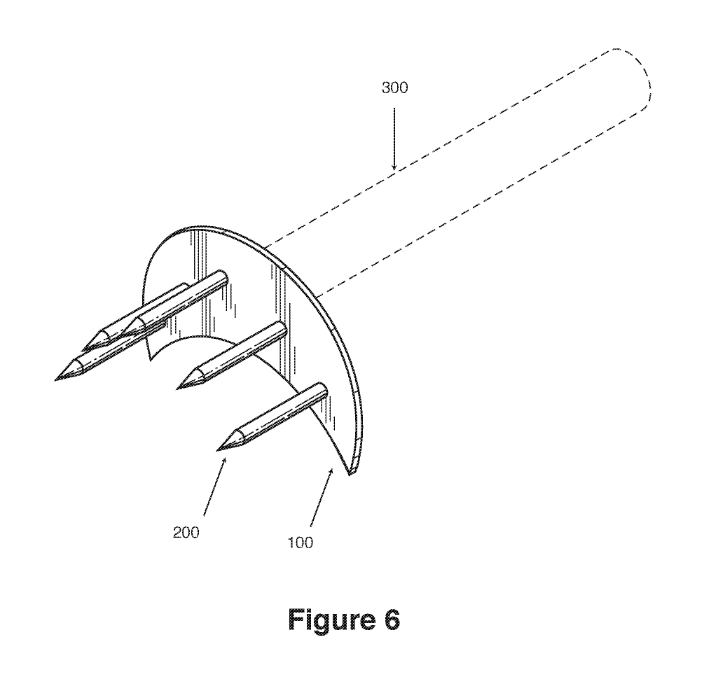

FIG. 6 illustrates an embodiment having five (5) tines 200. As one skilled in the art would recognize, the number of tines 200 that could be included on the tool 10 are only limited by the space available on the face surface 112 of the flat plate 110. Further, the tines can be organized as a single row that are spaced apart in relation to each other or as multiple rows that are spaced apart in relation to each other individually and/or spaced apart in relation to each row as whole.

The tool 10 can be made of any rigid material, such as but not limited to, metal, plastics, and composite materials. Further, the various components of the tool can each be made of different materials. For example, the base may be made of a metal while the shaft is made of a composite material.

A method for tampering and/or aerating soil and/or fertilizing a plant, particularly around the base of plants/trees, is now described. The methods described can be performed utilizing any aspect of the tool described by the disclosure herein. In one aspect, the methods may include the step of pressing or striking the surface of soil with a tool comprising a base comprising a substantially flat plate with a face surface and a back surface and one or more tines connected to and extending substantially perpendicular to a horizontal plane of the face surface of the flat plate, such that the face surface presses or strikes against the surface of the soil while the one or more tines pierce the surface of the soil. In another aspect, the methods may include the step of pressing or striking the surface of soil with a tool comprising a base comprising a substantially flat plate with a face surface and a back surface and one or more tines connected to and extending substantially perpendicular to a horizontal plane of the face surface of the flat plate, wherein the perimeter of the flat plate forms a substantially crescent shape having two pointed ends, such that the face surface presses or strikes against the surface of the soil while the one or more tines pierce the surface of the soil. The methods may further comprise twisting the tool while the tines are in the soil such that the one or more tines break up the surface of the soil. The methods may also further comprise applying nutrients and/or water and/or fertilize to the surface of the soil once the tool is utilized to pierce or break up the surface of the soil.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application and the scope of the appended claims.

1. A gardening tool, comprising:
a base comprising a substantially flat plate with a face surface and a back surface; and
one or more tines connected to and extending substantially perpendicular to a horizontal plane of the face surface of the flat plate, wherein the perimeter of the flat plate forms a substantially crescent shape having two pointed ends.

2. The tool of claim 1, further comprising a shaft extending substantially perpendicular to a horizontal plane of the back surface of the base.

3. The tool of claim 2, wherein the shaft comprises a handle.

4. The tool of claim 3, wherein the handle is removably attached to the shaft.

5. (canceled)

6. The tool of claim 1, wherein the one or more tines are in a substantially parallel spaced apart relation.

7. The tool of claim 1, wherein each of the one or more tines comprise an elongated stem having a head opposite the face surface of the flat plate, the head of the stem converging into a point.

8. The tool of claim 1, wherein the head of the stem converges into a diamond shaped point.

9. The tool of claim 1, wherein the one or more tines are removably connected to the flat plate.

10. The tool of claim 2, wherein the shaft is centrally positioned on the back surface of the base.

11. A method for tampering and/or aerating soil and/or fertilizing a plant, comprising pressing or striking the surface of soil with a tool comprising a base comprising a substantially flat plate with a face surface and a back surface and one or more tines connected to and extending substantially perpendicular to a horizontal plane of the face surface of the flat plate, wherein the perimeter of the flat plate forms a substantially crescent shape having two pointed ends such that the face surface presses or strikes against the surface of the soil while the one or more tines pierce the surface of the soil and the substantially crescent shape of the flat plate abuts the contour of the plant.

12. The method of claim 11, further comprising twisting the tool such that the one or more tines break up the surface of the soil.

13. The method of claim 11, further comprising applying nutrients and/or water and/or fertilize to the surface of the soil.

14. The method of claim 11, wherein the tool comprises a shaft extending substantially perpendicular to a horizontal plane of the back surface of the base.

15. The method of claim 14, wherein the shaft comprises a handle.

16. (canceled)

17. The method of claim 11, wherein the shaft is centrally positioned on the back surface of the base.
